(19) United States
(12) Patent Application Publication
(10) Pub. No.: US 2026/0138034 A1
(43) Pub. Date: May 21, 2026

(54) ADJUSTMENT METHOD AND APPARATUS FOR VIRTUAL SIGHTING TELESCOPE, DEVICE, AND STORAGE MEDIUM

(71) Applicant: Tencent technology (Shenzhen) Company Limited, Shenzhen (CN)

(72) Inventor: Boyi LIU, Shenzhen (CN)

(21) Appl. No.: 19/444,176

(22) Filed: Jan. 8, 2026

Related U.S. Application Data
(63) Continuation of application No. PCT/CN2024/113618, filed on Aug. 21, 2024.

(30) Foreign Application Priority Data
Oct. 24, 2023 (CN) 202311387078.9

(51) Int. Cl. A63F 13/837

(52) U.S. Cl. CPC A63F 13/837

(57) ABSTRACT

A method for adjusting a virtual sighting telescope is performed by a computer device. The method includes: displaying a first environment picture obtained by observing a virtual environment through the virtual sighting telescope; in response to a first operation for triggering adjustment of the virtual sighting telescope, obtaining first motion data collected by a gyroscope of the computer device for determining a posture change status of the computer device; and; in response to a second operation for adjusting a posture of the computer device, displaying a second environment picture obtained by observing the virtual environment through an adjusted virtual sighting telescope. When the adjustment of the virtual sighting telescope is triggered, picture display of the virtual sighting telescope can be adjusted only by adjusting the posture of the terminal device, thereby simplifying the operation of adjusting the virtual sighting telescope and improving efficiency of adjusting the virtual sighting telescope.

### CROSS-REFERENCE TO RELATED APPLICATIONS

This application is a continuation application of PCT Patent Application No. PCT/CN2024/113618, entitled “ADJUSTMENT METHOD AND APPARATUS FOR VIRTUAL SIGHTING TELESCOPE, DEVICE, AND STORAGE MEDIUM” filed on August 21, 2024, which claims priority to Chinese Patent Application 202311387078.9, entitled "ADJUSTMENT METHOD AND APPARATUS FOR VIRTUAL SIGHTING TELESCOPE, DEVICE, AND STORAGE MEDIUM" and filed on October 24, 2023, all of which are incorporated herein by reference in their entirety.

### FIELD OF THE TECHNOLOGY

Embodiments of this application relate to the technical field of computers, and in particular, to an adjustment method and apparatus for a virtual sighting telescope, a device, and a storage medium.

### BACKGROUND OF THE DISCLOSURE

In a virtual shooting scene, a user may observe and aim at a shooting target by using a virtual sighting telescope mounted on a virtual shooting prop.

In the related art, after clicking/tapping a related control (for example, a focus adjustment button corresponding to the virtual sighting telescope) of the virtual sighting telescope, the user may adjust a magnification of the virtual sighting telescope by sliding a button in a slide bar control (the slide bar control may indicate the magnification supported by the virtual sighting telescope), so as to more accurately aim at the shooting target.

However, in the foregoing method for adjusting the virtual sighting telescope, the user needs to perform a series of operations such as clicking/tapping, searching for the button in the slide bar, and sliding the button in the slide bar, which is relatively complex.

### SUMMARY

Embodiments of this application provide an adjustment method and apparatus for a virtual sighting telescope, a device, and a storage medium. The technical solutions provided in the embodiments of this application are as follows:

According to an aspect of the embodiments of this application, a method for adjusting a virtual sighting telescope is performed by a computer device, and the method including:

displaying a first environment picture obtained by observing a virtual environment through the virtual sighting telescope;

in response to a first operation for triggering adjustment of the virtual sighting telescope, obtaining first motion data collected by a gyroscope of the computer device for determining a posture change status of the computer device; and

in response to a second operation for adjusting a posture of the computer device, displaying a second environment picture obtained by observing the virtual environment through an adjusted virtual sighting telescope.

According to an aspect of the embodiments of this application, a computer device is provided, including a processor and a memory, the memory having a computer program stored therein, the computer program being loaded and executed by the processor to implement the foregoing adjustment method for a virtual sighting telescope.

According to an aspect of the embodiments of this application, a non-transitory computer-readable storage medium is provided, having a computer program stored therein, the computer program being loaded and executed by a processor to implement the foregoing adjustment method for a virtual sighting telescope.

The technical solutions provided in the embodiments of this application include at least the following beneficial effects:

A first environment picture obtained by observing a virtual environment through a virtual sighting telescope is displayed. Then, first motion data used for determining a posture change status of a terminal device is obtained in response to a first operation for triggering adjustment of the virtual sighting telescope. In addition, a second environment picture obtained by observing the virtual environment through an adjusted virtual sighting telescope is displayed in response to a second operation for adjusting a posture of the terminal device. In this way, when adjustment of the virtual sighting telescope is triggered, picture display of the virtual sighting telescope can be adjusted only by adjusting the posture of the terminal device, so that an operation of adjusting the virtual sighting telescope is simplified, and efficiency of adjusting the virtual sighting telescope is improved.

### BRIEF DESCRIPTION OF THE DRAWINGS

FIG. 1 is a schematic diagram of an implementation environment of a solution according to an embodiment of this application.

FIG. 2 is a schematic diagram of two types of virtual sighting telescopes according to an embodiment of this application.

FIG. 3 is a schematic diagram of a magnification adjustment process of a virtual sighting telescope according to an embodiment of this application.

FIG. 4 is a flowchart of an adjustment method for a virtual sighting telescope according to an embodiment of this application.

FIG. 5 is a schematic diagram of a first environment picture and a second environment picture according to an embodiment of this application.

FIG. 6 is a schematic diagram of enabling a gyroscope option in a game client according to an embodiment of this application.

FIG. 7 is a schematic diagram of a parameter adjustment interface according to an embodiment of this application.

FIG. 8 is a schematic diagram of a rotation direction of a terminal device according to an embodiment of this application.

FIG. 9 is a schematic diagram of adjusting a magnification of a virtual sighting telescope according to an embodiment of this application.

FIG. 10 is a schematic diagram of adjusting a magnification of a virtual sighting telescope according to another embodiment of this application.

FIG. 11 is a schematic diagram of a plurality of candidate parameters displayed in a longitudinal arrangement according to an embodiment of this application.

FIG. 12 is a schematic diagram of a plurality of candidate parameters displayed in a horizontal arrangement according to an embodiment of this application.

FIG. 13 is a flowchart of triggering and ending adjustment of a virtual sighting telescope according to an embodiment of this application.

FIG. 14 is a flowchart of an adjustment solution of a virtual sighting telescope according to an embodiment of this application.

FIG. 15 is a block diagram of an adjustment apparatus for a virtual sighting telescope according to an embodiment of this application.

FIG. 16 is a structural block diagram of a terminal device according to an embodiment of this application.

### DESCRIPTION OF EMBODIMENTS

To make the objectives, technical solutions, and advantages of this application clearer, the following further describes implementations of this application in detail with reference to the accompanying drawings.

FIG. 1 is a schematic diagram of an implementation environment of a solution according to an embodiment of this application. The implementation environment may include a terminal device 10 and a server 20.

The terminal device 10 may be an electronic device such as a mobile phone, a tablet computer, a multimedia playback device, a personal computer (PC), a wearable device, and an in-vehicle terminal device. A client running a target application may be installed in the terminal device 10. The target application may be a game application, such as a shooter game application, or another application that provides a shooter game. For example, the target application may be any one of a simulation program, a shooter game, a virtual reality (VR) application, an augmented reality (AR) application, a three-dimensional (3D) map program, a VR game, an AR game, a first-person shooter (FPS) game, a multiplayer gunfight survival game, a third-person shooter (TPS) game, a multiplayer online battle arena (MOBA) game, a simulation game (SLG), a social application, and an interactive entertainment application.

The server 20 may be configured to provide a backend service for the client of the target application (for example, a game application) in the terminal device 10. For example, the server 20 may be a backend server of the foregoing target application (for example, a game application). The server 20 may be one server, or may be a server cluster including a plurality of servers, or a cloud computing service center.

The terminal device 10 may communicate with the server 20 through a network, such as a wireless or wired network.

In addition, in this embodiment of this application, an implementation form of the target application is not limited. For example, the target application may be an application that needs to be downloaded and installed, a mini program that does not need to be installed, a web application, or the like.

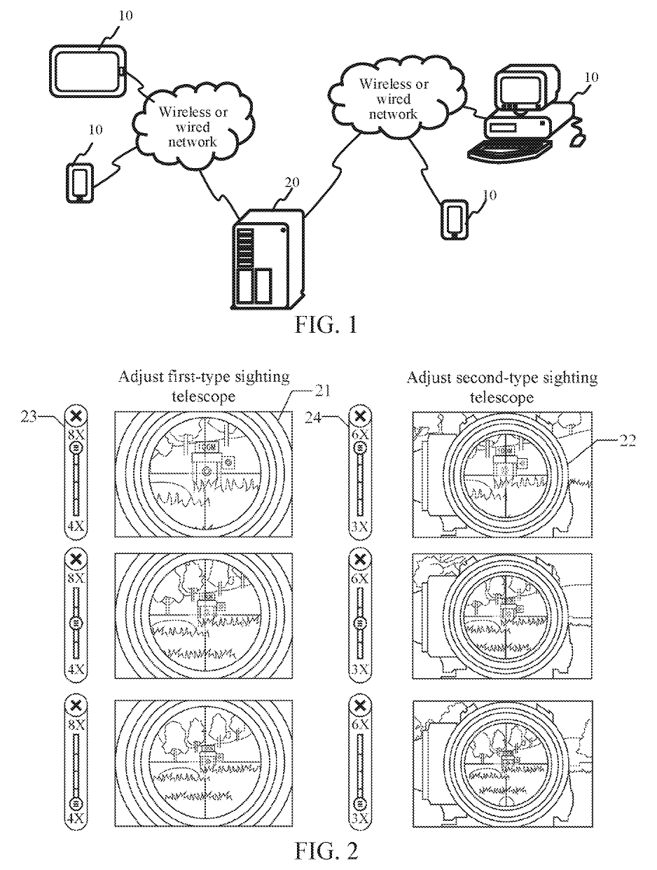

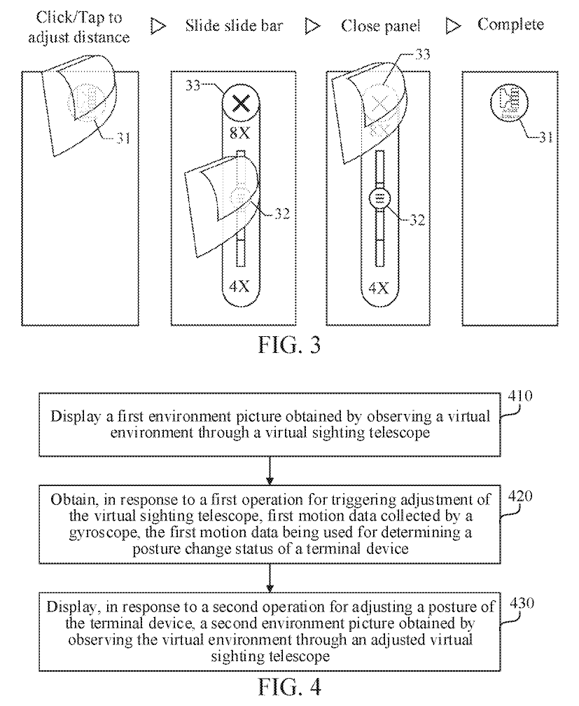

In a virtual shooting scene, a magnification of a virtual sighting telescope for a virtual environment is usually not fixed. That is, a same virtual sighting telescope may support zooming-in of a virtual environment at a plurality of magnifications. For example, referring to FIG. 2, a first-type virtual sighting telescope 21, as shown by a first slide bar control 23, may zoom in the virtual environment within a range of 4 times to 8 times. A second-type virtual sighting telescope 22, as shown by a second slide bar control 24, may zoom in the virtual environment within a range of 3 times to 6 times. The first-type virtual sighting telescope 21, the second-type virtual sighting telescope 22, the first slide bar control 23, and the second slide bar control 24 are not all marked in FIG. 2. FIG. 2 is described by using only some markings as an example. Therefore, for different shooting targets, the virtual sighting telescope may be correspondingly adjusted to facilitate aiming by a user. For example, when a shooting target is relatively close to a virtual character of the user, the magnification of the virtual sighting telescope may be decreased. When the shooting target is relatively far away from the virtual character of the user, the magnification of the virtual sighting telescope may be increased. It can be learned that, in the virtual shooting scene, adjusting the virtual sighting telescope is a high-frequency operation.

The following describes a process of adjusting a magnification of a virtual sighting telescope in the related art.

FIG. 3 is a schematic diagram of a magnification adjustment process of a virtual sighting telescope according to an embodiment of this application.

In the foregoing magnification adjustment process, first, the user needs to click/tap a distance adjustment button 31 in an interface, to open a slide bar for indicating a magnification range (which is 4 times to 8 times in FIG. 3) supported by the virtual sighting telescope. Then, the user needs to slide a slide button 32 in the slide bar to adjust the magnification. Finally, after the user completes the adjustment of the magnification, the user needs to click/tap a close button 33 to collapse the slide bar.

It can be learned that, the foregoing magnification adjustment process is relatively complex and is greatly different from an adjustment method for a real sighting telescope, lacking vicarious and immersive feelings of a shooting scene. To resolve the foregoing problem, the embodiments of this application provides a method for adjusting a virtual sighting telescope based on a posture change of a terminal device. For details, refer to the following embodiments.

FIG. 4 is a flowchart of an adjustment method for a virtual sighting telescope according to an embodiment of this application. Operations of the method are to be performed by a terminal device, for example, a client of a target application in the terminal device. A gyroscope is provided in the terminal device. The method may include at least one of the following operations 410 to 430.

Operation 410: Display a first environment picture obtained by observing a virtual environment through the virtual sighting telescope.

A gyroscope (also referred to as an angular velocity sensor) may be configured to measure a rotational angular velocity of a device when the device physically deflects or tilts, and is widely used in terminal devices and is mature and reliable. The gyroscope can accurately analyze and determine an actual action of the user, and the terminal device makes a corresponding interaction feedback according to this action, to complete a human-computer interaction process.

A virtual environment refers to a scene displayed by the terminal device and simulating the real world. The virtual environment may be displayed on a user interface (UI). A user may control a virtual character to move in the virtual environment. The virtual character is an object in the virtual environment that the user may control, and the virtual character may interact with the virtual environment. For example, in a shooter game, a virtual environment is displayed in a game interface, and a user may control a virtual character to move and shoot in the virtual environment.

In some embodiments, the virtual sighting telescope is a prop for assisting a virtual shooting prop in aiming. As a virtual prop, the virtual shooting prop has a function of releasing a shooting object. This application does not limit a type of the virtual shooting prop, and the virtual shooting prop includes, but is not limited to, a virtual catapult, a virtual crossbow, a virtual slingshot, and the like.

For example, one virtual shooting prop includes at least one projectile. In some embodiments, the projectile is considered as a virtual object belonging to the virtual shooting prop. For example, the projectile needs to be used in combination with a virtual shooting prop, but cannot be used alone. For example, if the virtual shooting prop is a virtual catapult, the projectile is a virtual stone used on the virtual catapult. For example, if the virtual shooting prop is a virtual crossbow, the projectile is a virtual arrow used on the virtual crossbow. For example, if the virtual shooting prop is a virtual slingshot, the projectile is a virtual marble on the virtual slingshot.

For example, the virtual sighting telescope serves for improving a hit ratio of the projectile of the virtual shooting prop.

In some embodiments, the virtual sighting telescope is mounted on the virtual shooting prop, to assist in aiming and shooting. The virtual shooting prop is a virtual prop used for shooting. For example, in a shooter game, a user may control a virtual character to obtain a virtual shooting prop by means of purchasing or picking, and use the virtual shooting prop to shoot. For example, the virtual sighting telescope is displayed on the virtual shooting prop in the virtual environment.

In some embodiments, the virtual sighting telescope is not mounted on the virtual shooting prop. In this case, the virtual sighting telescope may alternatively be used for observing a virtual scene. For example, in a shooter game, a virtual sighting telescope may be directly used to observe a virtual environment. For example, the virtual sighting telescope is not displayed on the virtual shooting prop in the virtual environment.

In some embodiments, the first environment picture obtained by observing the virtual environment through the virtual sighting telescope may be understood as follows: A virtual camera is mounted at a position of the virtual sighting telescope, an orientation of the virtual sighting telescope is used as an orientation of the virtual camera, and a picture obtained by observing the virtual environment is used as the displayed first environment picture. For example, the orientation of the virtual sighting telescope is the same as or different from an orientation of the virtual shooting prop. For example, when the virtual sighting telescope is mounted on the virtual shooting prop, the orientation of the virtual sighting telescope is the same as the orientation of the virtual shooting prop. For example, when the virtual sighting telescope is not mounted on the virtual shooting prop, the orientation of the virtual sighting telescope may be different from the orientation of the virtual shooting prop.

In some embodiments, the virtual sighting telescope is configured to zoom in or zoom out the virtual environment. For example, the first environment picture is a picture obtained after the virtual environment is zoomed in. In some other embodiments, the virtual sighting telescope may not zoom in the virtual environment for display. For example, when the shooting target is relatively close to the virtual character of the user, the user only needs to use an aiming point in the virtual sighting telescope to aim at the shooting target, and does not need to zoom in on the virtual environment. For example, the first environment picture is a picture obtained after the virtual environment is zoomed out.

The first environment picture refers to a picture obtained by observing the virtual environment through the virtual sighting telescope.

When the virtual sighting telescope is in an open (that is, expanded) state, the expanded virtual sighting telescope is displayed in the UI, and the first environment picture is displayed in an observation area corresponding to the expanded virtual sighting telescope.

For example, referring to FIG. 5, a first environment picture 52 may be observed through a virtual sighting telescope 51.

Operation 420: Obtain, in response to a first operation for triggering adjustment of the virtual sighting telescope, first motion data collected by the gyroscope, the first motion data being used for determining a posture change status of the terminal device.

In some embodiments, the first motion data is data indicating a posture of the terminal device. For example, in some embodiments, the first motion data includes at least one of the following: angular velocity data of the terminal device, angular acceleration data of the terminal device, position data of the terminal device, and rotation direction data of the terminal device.

In some embodiments, in response to the first operation for triggering adjustment of the virtual sighting telescope, it is determined to enable the gyroscope, and the first motion data is obtained after the gyroscope is enabled. For example, after the gyroscope is enabled, the first motion data is collected every threshold time (for example, every 0.5s). For example, data of each time is referred to as first motion data, but first motion data collected at different time points may be different (the posture of the terminal device changes).

In some embodiments, the first motion data is used for determining the posture change status of the terminal device. The posture change status of the terminal device is a change status of the posture of the terminal device. For example, the posture change status of the terminal device includes, but is not limited to, a change status of a rotation direction of the terminal device, a change status of a rotation angle of the terminal device, and a change status of a position of the terminal device.

In some embodiments, the posture change status of the terminal device is determined based on a change status between first motion data collected at a first moment and first motion data collected at a second moment. The first moment and the second moment are different moments after the gyroscope is enabled to collect data.

In some embodiments, the first motion data is rotation direction and rotation angle data of the terminal device that are determined based on the angular velocity data.

The posture change status of the terminal device may include the terminal device being rotated, or tilted, or the like.

In this embodiment of this application, to distinguish from another operation, an operation for triggering adjustment of the virtual sighting telescope is referred to as a first operation. That "the first operation is used for triggering adjustment of the virtual sighting telescope" means that when the first operation is performed, the virtual sighting telescope starts to be adjusted. In some embodiments, "triggering adjustment of the virtual sighting telescope" may also be referred to as entering a particular mode. In this mode, the user may adjust the virtual sighting telescope. For example, in this mode, the gyroscope is enabled or activated.

In some embodiments, the gyroscope is activated in response to the first operation, and the gyroscope starts to collect the first motion data.

In some embodiments, the gyroscope continuously collects the first motion data, and the first motion data collected by the gyroscope is obtained in response to the first operation.

In some embodiments, the first operation includes an operation on a first control, and the first control is a UI control configured to trigger adjustment of the virtual sighting telescope. For example, an operation type of the operation on the first control includes, but is not limited to: a click/tap operation, a touch and hold operation, or a double-click/tap operation. The first control is provided in the UI. For example, the first control may be provided in a game interface. The first control may be displayed in the UI in a form of a button, a slide bar, a text option, or the like. This is not limited in this application.

In some embodiments, the UI control is any visual control or element that can be seen in a UI of an application, such as a picture, an input box, a text box, a button, and a label. Some of UI controls respond to a user operation. For example, the first control is configured to trigger adjustment of the virtual sighting telescope. The user triggers the first control, to start to adjust the virtual sighting telescope. UI controls involved in the embodiments of this application include, but are not limited to: a first control, a second control, and a cancel option.

In some embodiments, the first control is always displayed in the UI. In some embodiments, the first control has a particular appearance timing. In some embodiments, the first control is displayed in response to an open operation by the user. The open operation by the user refers to an operation that the user expands the virtual sighting telescope. The user can observe the virtual environment through the virtual sighting telescope only after the virtual sighting telescope is expanded. In some embodiments, the virtual sighting telescope may be expanded by clicking/tapping an open control in the UI.

In some embodiments, the operation on the first control is a touch and hold operation on the first control. That is, the user may trigger adjustment of the virtual sighting telescope by touching and holding the first control. The touch and hold operation on the first control refers to a continuous press operation on the first control. That is, a press operation on the first control for more than a set duration may be referred to as a touch and hold operation on the first control. The set duration may be a second threshold in the following embodiments.

In some embodiments, the operation on the first control is a click/tap operation on the first control. That is, the user may trigger adjustment of the virtual sighting telescope by clicking/tapping the first control. The click/tap operation on the first control refers to a press operation on the first control for a short period of time. That is, a press operation on the first control for less than a set duration may be referred to as a click/tap operation on the first control.

In some embodiments, the first operation may further include an operation such as sliding or dragging on the first control. This is not limited in this application.

According to the foregoing method, the first control is set to control a condition of triggering adjustment of the virtual sighting telescope, so that the user can select, according to a requirement of the user, whether to adjust the virtual sighting telescope, thereby avoiding occurrence of a case such as a false touch, and improving adjustment efficiency.

In some embodiments, in response to the operation on the first control when duration of the operation on the first control is greater than or equal to a second threshold, the first motion data collected by the gyroscope is obtained.

In this embodiment of this application, to distinguish between motion data collected by the gyroscope and motion data collected by another sensor (such as an acceleration sensor), the motion data collected by the gyroscope is referred to as first motion data.

The second threshold may be set by a technical person according to requirements, for example, may be set to 0.2 second, 0.3 second, or 0.5 second. This is not limited in this application.

In some embodiments, the first motion data collected by the gyroscope is obtained in response to that the duration of touching and holding the first control is greater than or equal to the second threshold. Further, when the first control is held down (that is, continuously pressed), the first motion data collected by the gyroscope is continuously obtained.

According to the foregoing method, the duration of the operation on the first control is set, so that it can be effectively avoided that the user triggers adjustment of the virtual sighting telescope due to an accidental touch on the first control.

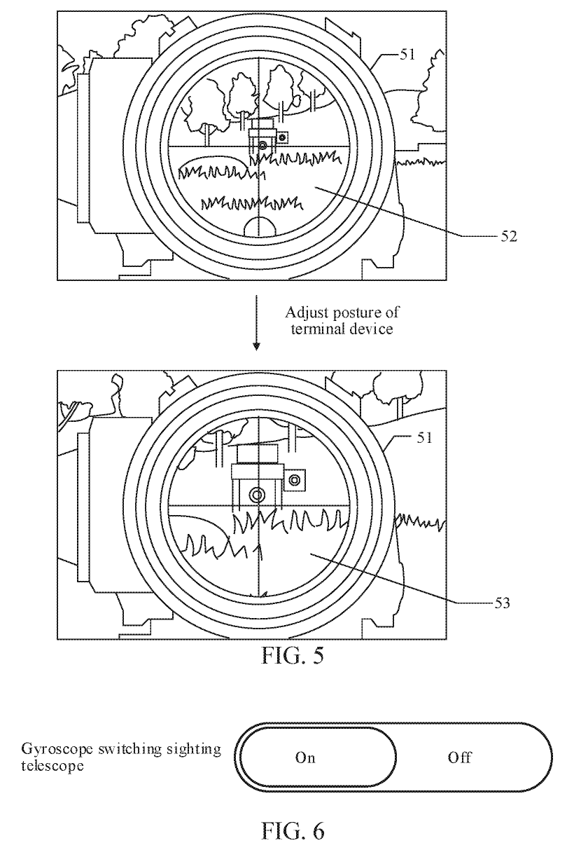

In some embodiments, the technical solutions provided in this embodiment of this application are applied to a game client. Before the first motion data collected by the gyroscope is obtained in response to the first operation for triggering adjustment of the virtual sighting telescope, the game client further needs to be allowed to enable the gyroscope to adjust the sighting telescope. For example, after a "gyroscope switching sighting telescope" option, shown in FIG. 6, in the game client is turned on, the first motion data collected by the gyroscope is obtained in response to the first operation for triggering adjustment of the virtual sighting telescope. The "gyroscope switching option" may be displayed in a settings interface of the game client. Further, a settings option may be displayed in the game interface (for example, displayed in a form of an icon or text). If the user clicks/taps the settings option, the settings interface is displayed in the game interface. The user may enable the "gyroscope switching sighting telescope" option in the settings interface through a clicking/tapping operation, a sliding operation, or the like.

Operation 430: Display, in response to a second operation for adjusting a posture of the terminal device, a second environment picture obtained by observing the virtual environment through an adjusted virtual sighting telescope.

A parameter of the adjusted virtual sighting telescope is obtained after a parameter of the virtual sighting telescope is adjusted based on the first motion data.

For example, when the second operation is performed, if the posture of the terminal device changes, the first motion data also continuously changes. For example, the posture change status of the terminal device is determined based on a plurality of groups of collected first motion data, and a parameter corresponding to the posture change status is further determined. For example, the parameter of the virtual sighting telescope is adjusted by using the parameter to obtain the adjusted virtual sighting telescope. For example, different parameters are configured for different posture change statuses in advance to obtain configuration information. After the posture change status is determined based on the first motion data, the parameter is directly determined from the configuration information. For example, the parameter is used as the parameter of the adjusted virtual sighting telescope.

In some embodiments, the second operation is an operation directly on the terminal device, rather than an operation of interacting with a control in a user interaction interface. In this embodiment of this application, to distinguish from other operations, an operation for adjusting the posture of the terminal device is referred to as a second operation. That "the second operation is used for adjusting the posture of the terminal device" means that when the second operation is performed, the posture of the terminal device changes. That is, the second operation may refer to an operation of moving the terminal device by the user, and may include an operation such as rotation, tilt, or displacement on the terminal device.

The second environment picture refers to a picture obtained by observing the virtual environment through the adjusted virtual sighting telescope.

The second environment picture may be changed compared with the first environment picture. For example, compared with the first environment picture, the second environment picture may be zoomed for display, for example, the picture is zoomed in or zoomed out. Alternatively, compared with the first environment picture, the second environment picture may have brightness changed, for example, the brightness becomes higher or becomes lower. Alternatively, compared with the first environment picture, the second environment picture may have clarity changed, for example, the picture becomes clearer or more blurred. Alternatively, compared with the first environment picture, the second environment picture may have a style of an aiming point or an aiming line of the virtual sighting telescope in the picture changed. For example, the aiming point or the aiming line changes from a dark color to a light color.

For example, referring to FIG. 5, in response to the second operation for adjusting the posture of the terminal device, a second environment picture 53 may be observed through the virtual sighting telescope 51. Compared with the first environment picture 52, the second environment picture 53 is zoomed in for display.

In the technical solution provided in this embodiment of this application, a first environment picture obtained by observing a virtual environment through a virtual sighting telescope is displayed. Then, first motion data used for determining a posture change status of a terminal device is obtained in response to a first operation for triggering adjustment of the virtual sighting telescope. In addition, a second environment picture obtained by observing the virtual environment through an adjusted virtual sighting telescope is displayed in response to a second operation for adjusting a posture of the terminal device. In this way, when adjustment of the virtual sighting telescope is triggered, picture display of the virtual sighting telescope can be adjusted only by adjusting the posture of the terminal device, so that an operation of adjusting the virtual sighting telescope is simplified, and efficiency of adjusting the virtual sighting telescope is improved.

The foregoing embodiments mainly relate to adjusting, according to the posture change status of the terminal device, a display status of an environment picture obtained by observing the virtual environment through the virtual sighting telescope. In some embodiments, a parameter change status of the virtual sighting telescope may further be intuitively prompted. This is described in detail in the following embodiments.

In some embodiments, prompt information is displayed in response to the second operation, the prompt information being configured for indicating a parameter in a selected state among a plurality of candidate parameters, the plurality of candidate parameters being parameters supported by the virtual sighting telescope, and the parameter in the selected state being determined by the posture of the terminal device adjusted by the second operation.

For example, there are at least three display timings for the prompt information in this application. First, when the second operation starts to be performed, the prompt information starts to be displayed. The prompt information is not displayed when performing of the second operation ends. That is, a display time of the prompt information corresponds to an operation time of the second operation. Second, the prompt information is displayed only when the posture of the terminal device that is adjusted by the second operation causes the parameter in the selected state to change, and the prompt information is not displayed when the parameter in the selected state does not change. Third, after the second operation ends, that is, after the finally selected parameter is determined, the prompt information is displayed, for prompting to determine the selected parameter used for adjusting the virtual sighting telescope.

For example, the prompt information is configured for indicating the parameter in the selected state among the plurality of candidate parameters. For example, the prompt information indicates the parameter in the selected state in a form such as text, voice, or an icon. For example, when the prompt information is in a form of voice, displaying the prompt information is playing the prompt information. For example, the parameter in the selected state is played.

In some embodiments, the second environment picture is displayed in response to an end operation of the second operation or an end operation of the first operation, the parameter of the adjusted virtual sighting telescope being the parameter in the selected state.

For example, the end operation of the first operation is an operation for ending triggering of adjustment of the virtual sighting telescope. For example, if the first operation is a touch and hold operation on the first control, when the touch and hold operation ends, a finger leaves the screen, and it is considered that the end operation of the first operation is performed. For example, if the first operation is a click/tap operation on the first control, when the click/tap operation on the first control is performed again to end triggering of adjustment of the virtual sighting telescope, the click/tap operation performed again herein is the end operation of the first operation.

For example, the end operation of the second operation is an operation for ending adjustment of the posture of the terminal device. For example, when the terminal device does not receive the second operation on the terminal device within the threshold time, it is considered that the adjustment of the posture of the terminal device ends. In this case, it is considered that the end operation of the second operation is performed.

For example, the end operation of the second operation or the end operation of the first operation herein both refer to an operation of exiting adjustment of the virtual sighting telescope. For example, after the operation is performed, the gyroscope may be caused to change from an active state to an inactive state, and the gyroscope in the inactive state no longer collects the first motion data. For example, when the gyroscope no longer collects the first motion data, the parameter of the virtual sighting telescope cannot be adjusted based on the posture change status. In other words, the parameter of the virtual sighting telescope is no longer adjusted.

In some embodiments, the second environment picture is displayed in response to an operation of exiting the adjustment of the virtual sighting telescope, and the parameter of the adjusted virtual sighting telescope is the parameter in the selected state. In addition to the end operation of the second operation or the end operation of the first operation, the operation of exiting the adjustment of the virtual sighting telescope may also be an operation on a second control. The second control is a UI control. For example, the second control and the first control are the same control or different controls.

In the technical solution provided in this embodiment of this application, prompt information is displayed to indicate a parameter in a selected state. This helps continue to adjust a posture of a terminal device when the parameter in the selected state does not meet an expectation of a user, so as to obtain a parameter that meets the expectation, thereby causing an adjustment effect of a virtual sighting telescope to meet the expectation. In some embodiments, the adjustment method for a virtual sighting telescope further includes: displaying a parameter adjustment interface of the virtual sighting telescope, the parameter adjustment interface displaying the prompt information and the plurality of candidate parameters supported by the virtual sighting telescope, and the prompt information being configured to mark the parameter in the selected state from the plurality of candidate parameters. The parameter adjustment interface is displayed in a UI. In some embodiments, the parameter adjustment interface may be displayed in an environment picture (for example, the first environment picture) observed through the virtual sighting telescope. In some embodiments, the parameter adjustment interface may be displayed outside the environment picture observed through the virtual sighting telescope, for example, around the virtual sighting telescope (above, below, to the left of, or to the right of the virtual sighting telescope). In the parameter adjustment interface, the parameter in the selected state may be used for indicating a current parameter of the virtual sighting telescope.

For example, when the first environment picture and the parameter adjustment interface are simultaneously displayed in the UI, if the magnification "6X" is marked in the parameter adjustment interface, it indicates that the magnification currently used by the virtual sighting telescope is 6 times, and compared with the corresponding virtual environment, the first environment picture is zoomed in by 6 times.

In some embodiments, the parameter adjustment interface of the virtual sighting telescope is displayed in response to the first operation (or after the first operation). In other words, obtaining the first motion data and displaying the parameter adjustment interface of the virtual sighting telescope may be performed at the same time. For example, after the user touches and holds or clicks/taps the first control, the first motion data is obtained, and the parameter adjustment interface of the virtual sighting telescope is displayed.

In some embodiments, the parameter adjustment interface of the virtual sighting telescope is displayed in response to the second operation (or after the second operation). In other words, displaying the second environment picture obtained by observing the virtual environment through the adjusted virtual sighting telescope and displaying the parameter adjustment interface of the virtual sighting telescope may be performed at the same time. For example, after the user rotates or tilts the terminal device, the second environment picture obtained by observing the virtual environment through the adjusted virtual sighting telescope is displayed, and the parameter adjustment interface of the virtual sighting telescope is displayed.

The plurality of candidate parameters supported by the virtual sighting telescope may be a plurality of different magnifications supported by the virtual sighting telescope, or may be other types of parameters, for example, a plurality of different picture display brightnesses supported by the virtual sighting telescope (that is, the brightnesses of the environment pictures observed through the virtual sighting telescope), a plurality of different picture display clarities supported by the virtual sighting telescope (that is, the clarities of the environment pictures observed through the virtual sighting telescope), and a plurality of different styles of aiming points or aiming lines supported by the virtual sighting telescope (for example, aiming points or aiming lines having different patterns or different colors).

The prompt information may be represented by displaying the parameter in the selected state in different colors or patterns, or by displaying a particular symbol (such as an arrow) to mark the parameter in the selected state. This application does not limit the representation form of the prompt information.

In some embodiments, the plurality of candidate parameters are arranged in a particular sequence and direction in the parameter adjustment interface, for example, arranged one by one along a straight line based on values of the parameters.

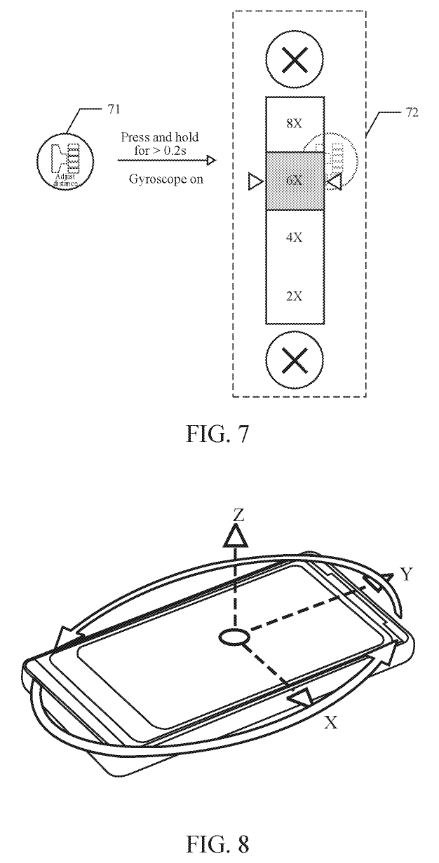

For example, referring to FIG. 7, a parameter adjustment interface 72 of the virtual sighting telescope is displayed in response to a duration for touching and holding a first control 71 exceeding 0.2s, a plurality of candidate magnifications supported by the virtual sighting telescope being displayed in the parameter adjustment interface 72. The magnification "6X" is in a selected state.

According to the foregoing method, the parameter adjustment interface is set, so that the user can learn, in real time, a parameter value currently corresponding to the virtual sighting telescope while adjusting the virtual sighting telescope, thereby improving accuracy of parameter adjustment performed on the virtual sighting telescope.

In some embodiments, a first parameter type to be adjusted is determined from a plurality of parameter types of the virtual sighting telescope according to the first operation or the second operation. In addition, a parameter adjustment interface of the first parameter type is displayed. The parameter adjustment interface of the first parameter type is an interface for adjusting a parameter of the first parameter type.

The plurality of parameter types may include a magnification of the virtual sighting telescope, a picture display brightness, a picture display clarity, a style of an aiming point or an aiming line in the virtual sighting telescope, and the like.

In some embodiments, the plurality of parameter types may correspond to different controls, and the first parameter type to be adjusted may be determined from the plurality of parameter types of the virtual sighting telescope according to first operations (such as clicking/tapping and touching and holding) on different controls. For example, it is assumed that a magnification adjustment control, a brightness adjustment control, a clarity adjustment control, an aiming point adjustment control, and the like are simultaneously displayed in the UI. In this case, the first parameter type may be determined as a magnification according to an operation performed by the user on the magnification adjustment control, or the first parameter type may be determined as a picture display brightness according to an operation performed by the user on the brightness adjustment control, or the first parameter type may be determined as a picture display clarity according to an operation performed by the user on the clarity adjustment control, or the first parameter type may be determined as a style of an aiming point or an aiming line of the virtual sighting telescope according to an operation performed by the user on the aiming point adjustment control.

In some embodiments, the plurality of parameter types may correspond to different rotation axes, and the first parameter type to be adjusted may be determined from the plurality of parameter types of the virtual sighting telescope according to rotation operations around different axes. For example, if the terminal device rotates around an axis perpendicular to a plane in which a screen of the terminal device is located, the first parameter type is a magnification. If the terminal device rotates around an axis parallel to a plane in which a screen of the terminal device is located, the first parameter type is a picture display brightness.

In the foregoing method, various types of parameters of the virtual sighting telescope may be selectively adjusted by adjusting the posture of the terminal device, to improve adjustment efficiency and adjustment accuracy of the virtual sighting telescope.

In some embodiments, when the terminal device rotates around a first axis toward a first direction and a rotation angle is greater than or equal to a first threshold, it is displayed that the parameter in the selected state changes from a first parameter to a second parameter.

In some embodiments, when the terminal device rotates around a second axis toward a second direction and a rotation angle is greater than or equal to a first threshold, it is displayed that the parameter in the selected state changes from a first parameter to a third parameter, the second parameter being different from the third parameter. The first axis and the second axis are a same axis, and the first direction and the second direction are different directions. Alternatively, the first axis and the second axis are different axes, and the first direction and the second direction are a same direction or different directions.

In a first case, the first axis and the second axis are a same axis, and the first direction and the second direction are different directions.

For example, the first direction is an anticlockwise direction, and the second direction is a clockwise direction. For example, when the terminal device rotates around the first axis toward the anticlockwise direction and the rotation angle is greater than or equal to the first threshold, it is displayed that the parameter in the selected state changes from the first parameter to the second parameter. For example, when the terminal device rotates around the first axis toward the clockwise direction and the rotation angle is greater than or equal to the first threshold, it is displayed that the parameter in the selected state changes from the first parameter to the third parameter.

For example, the first direction is a clockwise direction, and the second direction is an anticlockwise direction. For example, when the terminal device rotates around the first axis toward the clockwise direction and the rotation angle is greater than or equal to the first threshold, it is displayed that the parameter in the selected state changes from the first parameter to the second parameter. For example, when the terminal device rotates around the first axis toward the anticlockwise direction and the rotation angle is greater than or equal to the first threshold, it is displayed that the parameter in the selected state changes from the first parameter to the third parameter.

For example, if the second parameter is greater than the first parameter, the third parameter is less than the first parameter. For example, if the second parameter is less than the first parameter, the third parameter is greater than the first parameter. That is, rotation toward different directions corresponds to adjustment in different parameter directions (a parameter increasing direction or a parameter decreasing direction).

In a second case, the first axis and the second axis are different axes, and the first direction and the second direction are a same direction.

For example, the first direction and the second direction are anticlockwise directions. For example, when the terminal device rotates around the first axis toward the anticlockwise direction and the rotation angle is greater than or equal to the first threshold, it is displayed that the parameter in the selected state changes from the first parameter to the second parameter. For example, when the terminal device rotates around the second axis toward the anticlockwise direction and the rotation angle is greater than or equal to the first threshold, it is displayed that the parameter in the selected state changes from the first parameter to the third parameter.

For example, the first direction and the second direction are clockwise directions. For example, when the terminal device rotates around the first axis toward the clockwise direction and the rotation angle is greater than or equal to the first threshold, it is displayed that the parameter in the selected state changes from the first parameter to the second parameter. For example, when the terminal device rotates around the second axis toward the clockwise direction and the rotation angle is greater than or equal to the first threshold, it is displayed that the parameter in the selected state changes from the first parameter to the third parameter.

For example, if the second parameter is greater than the first parameter, the third parameter is less than the first parameter. For example, if the second parameter is less than the first parameter, the third parameter is greater than the first parameter. That is, different axes correspond to adjustment in different parameter directions (a parameter increasing direction or a parameter decreasing direction).

In a third case, the first axis and the second axis are different axes, and the first direction and the second direction are different directions. The first direction is an anticlockwise direction, or the second direction is a clockwise direction.

For example, the first direction is an anticlockwise direction, and the second direction is a clockwise direction. For example, when the terminal device rotates around the first axis toward the anticlockwise direction and the rotation angle is greater than or equal to the first threshold, it is displayed that the parameter in the selected state changes from the first parameter to the second parameter. For example, when the terminal device rotates around the second axis toward the anticlockwise direction and the rotation angle is greater than or equal to the first threshold, it is displayed that the parameter in the selected state changes from the first parameter to the third parameter.

For example, the first direction is a clockwise direction, and the second direction is an anticlockwise direction. For example, when the terminal device rotates around the first axis toward the clockwise direction and the rotation angle is greater than or equal to the first threshold, it is displayed that the parameter in the selected state changes from the first parameter to the second parameter. For example, when the terminal device rotates around the second axis toward the anticlockwise direction and the rotation angle is greater than or equal to the first threshold, it is displayed that the parameter in the selected state changes from the first parameter to the third parameter.

For example, if the second parameter is greater than the first parameter, the third parameter is less than the first parameter. For example, if the second parameter is less than the first parameter, the third parameter is greater than the first parameter. That is, different axes and different rotation directions correspond to adjustment in different parameter directions (a parameter increasing direction or a parameter decreasing direction).

In some other embodiments, a parameter adjustment range is determined according to a range of an angle of rotation of the terminal device around the axis. For example, the angle of rotation is greater than a first threshold, and a larger angle of rotation indicates a larger parameter adjustment range, that is, a larger span from the first parameter to the second parameter, or a larger span from the first parameter to the third parameter.

In some embodiments, when the terminal device rotates around a first axis toward a first direction, when a rotation angle is greater than or equal to a first threshold, the parameter in the selected state changes from a first parameter to a second parameter.

In some embodiments, when the terminal device rotates around a first axis toward a second direction, when a rotation angle is greater than or equal to a first threshold, the parameter in the selected state changes from a first parameter to a third parameter.

The first threshold may be set based on an operation habit of a user. For example, the first threshold may be adjusted according to game operation sensitivity set by the user. For example, if the user sets the sensitivity to be high, the first threshold may be set to be relatively small, for example, 10 degrees or 15 degrees. If the user sets the sensitivity to be low, the first threshold may be set to be relatively large, for example, 20 degrees or 30 degrees.

In some embodiments, the user may adjust the game operation sensitivity in the settings interface of the game client. When the game operation sensitivity changes, the first threshold also correspondingly changes. For a specific introduction of the settings interface, refer to the foregoing embodiment. Details are not described herein again.

The first axis refers to a rotation axis with reference to which the terminal device performs a rotation operation.

The first direction is opposite to the second direction, and the second parameter is different from the third parameter. In some embodiments, the first direction is a clockwise direction around the first axis, and correspondingly, the second direction is an anticlockwise direction around the first axis. In some embodiments, the first direction is an anticlockwise direction around the first axis, and correspondingly, the second direction is a clockwise direction around the first axis. For example, referring to FIG. 8, for the terminal device, a center point of a screen of the terminal device may be used as a coordinate origin, a straight line passing through the coordinate origin and perpendicular to a plane in which the screen of the terminal device is located is used as a z-axis, a straight line passing through the coordinate origin and perpendicular to a shorter side of the screen of the terminal device is used as a y-axis, and a straight line passing through the coordinate origin and perpendicular to a longer side of the screen of the terminal device is used as an x-axis, thereby constructing a coordinate system. Further, if the z-axis is used as the first axis, an anticlockwise direction around the z-axis shown in FIG. 8 may be used as the second direction, and correspondingly, a clockwise direction is the first direction. For example, the first axis is one of the x-axis, the y-axis, and the z-axis herein. For example, the second axis is one of the x-axis, the y-axis, and the z-axis herein.

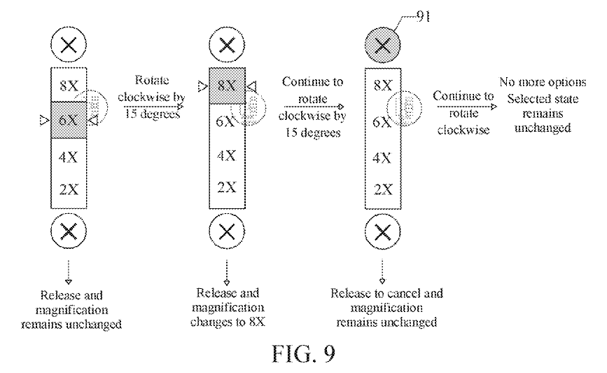

For example, referring to FIG. 9, when the terminal device rotates clockwise around the first axis by 15 degrees, the magnification in the selected state changes from "6X" to "8X".

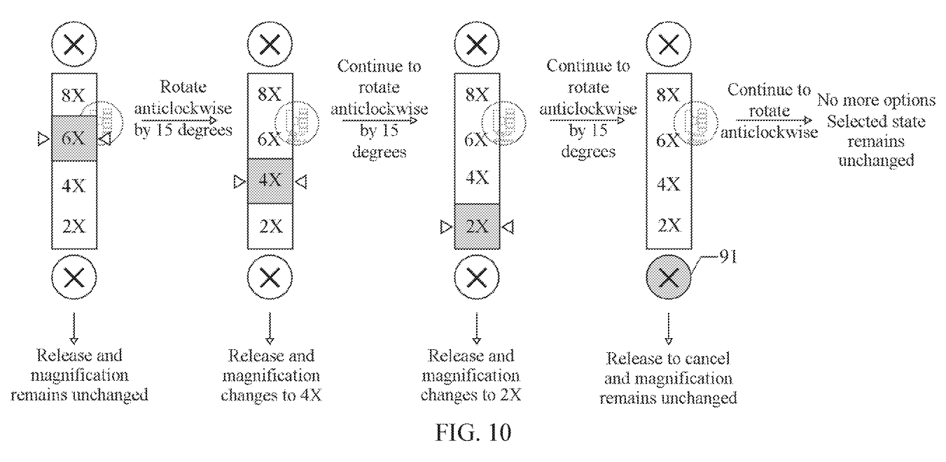

For example, referring to FIG. 10, when the terminal device rotates anticlockwise around the first axis by 15 degrees, the magnification in the selected state first changes from "6X" to "4X", and then changes from "4X" to "2X" after the next time of anticlockwise rotation by 15 degrees.

For example, when the terminal device rotates clockwise around the first axis by 15 degrees, a picture display brightness in the selected state changes from "medium brightness" to "high brightness". When the terminal device rotates anticlockwise around the first axis by 15 degrees, the picture display brightness in the selected state changes from "medium brightness" to "low brightness".

For example, when the terminal device rotates clockwise around the first axis by 15 degrees, a picture display clarity in the selected state changes from "medium quality" to "high quality". When the terminal device rotates anticlockwise around the first axis by 15 degrees, the picture display brightness in the selected state changes from "medium quality" to "low quality".

For example, when the terminal device rotates clockwise around the first axis by 15 degrees, a front sight style in the selected state changes from "default front sight" to "dark-colored front sight". When the terminal device rotates anticlockwise around the first axis by 15 degrees, the front sight style in the selected state changes from "default front sight" to "light-colored front sight".

In addition, in some embodiments, when the parameter in the selected state changes, the picture obtained by observing the virtual environment through the virtual sighting telescope also changes correspondingly.

For example, if the first environment picture corresponds to a magnification of 6 times of the virtual sighting telescope, when a magnification in the selected state changes from "6X" to "8X", the second environment picture is zoomed in compared with the first environment picture. When the magnification in the selected state changes from "6X" to "4X", the second environment picture is zoomed out compared with the first environment picture.

For example, if the brightness of the first environment picture is medium brightness, when the picture display brightness in the selected state changes from "medium brightness" to "high brightness", the brightness of the second environment picture increases compared with the brightness of the first environment picture. When the picture display brightness in the selected state changes from "medium brightness" to "low brightness", the brightness of the second environment picture decreases compared with the brightness of the first environment picture.

For example, if the clarity of the first environment picture is medium quality, when the picture display clarity in the selected state changes from "medium quality" to "high quality", the clarity of the second environment picture is improved compared with the clarity of the first environment picture. When the picture display brightness in the selected state changes from "medium quality" to "low quality", the clarity of the second environment picture is reduced compared with the clarity of the first environment picture.

For example, if a front sight style of the virtual sighting telescope in the first environment picture is a default front sight, when the front sight style in the selected state changes from "default front sight" to "dark-colored front sight", the color of the front sight in the second environment picture becomes darker than that of the front sight in the first environment picture. When the front sight style in the selected state changes from "default front sight" to "light-colored front sight", the color of the front sight in the second environment picture is lightened compared with that of the front sight in the first environment picture.

In the foregoing method, a direction in which a parameter of a virtual sighting telescope is adjusted (for example, a magnification is increased or decreased) is selected by selecting different rotation directions, which simulates a manner of adjusting a magnification of a sighting telescope in the real world and is relatively convenient. Further, the direction in which the parameter of the virtual sighting telescope is adjusted may also be selected based on axes, thereby enriching forms of adjusting the parameter of the virtual sighting telescope, and improving human-computer interaction efficiency.

In some embodiments, when the parameter in the selected state changes, the terminal device is controlled to generate a vibration feedback.

For example, referring to FIG. 10, when the magnification in the selected state changes from "6X" to "4X", the terminal device is controlled to vibrate, and when the magnification in the selected state changes from "4X" to "2X", the terminal device is controlled to vibrate again.

According to the foregoing method, a user can be prompted, through somatosensory perception, that a parameter of a virtual sighting telescope changes, thereby ensuring that the user selects a parameter meeting a requirement of the user. This manner helps improve perception of the user about a parameter change, so that the user can continue to adjust or does not adjust a posture of the terminal device, thereby enriching human-computer interaction forms, and also improving human-computer interaction efficiency.

In some embodiments, the parameter in the selected state is determined as the parameter of the adjusted virtual sighting telescope in response to a third operation for confirming a selection. In some embodiments, the third operation for confirming a selection includes at least one of the end operation of the second operation, the end operation of the first operation, and the operation on the second control. For the end operation of the second operation, or the end operation of the first operation, or the operation on the second control, refer to the explanations and descriptions in the foregoing embodiments. Details are not described herein again.

The third operation is an operation for confirming a selection, and further, refers to an operation for confirming the selection of the parameter of the adjusted virtual sighting telescope.

In some embodiments, the third operation is used for ending adjustment of the virtual sighting telescope. In other words, after the third operation is performed, the parameter of the virtual sighting telescope is no longer adjusted in response to the second operation for adjusting the posture of the terminal device. In some embodiments, the display of the parameter adjustment interface is canceled in response to the third operation. In some embodiments, the obtaining of the first motion data collected by the gyroscope is stopped in response to the third operation.

In some embodiments, the third operation is a click/tap on the first control or stopping touching and holding on the first control.

In some embodiments, the first operation is a click/tap operation on the first control. Correspondingly, in response to another click/tap on the first control, the parameter in the selected state is determined as the parameter of the adjusted virtual sighting telescope.

In some embodiments, the first operation is a touch and hold operation on the first control. Correspondingly, the parameter in the selected state is determined as the parameter of the adjusted virtual sighting telescope in response to stopping of the touching and holding on the first control.

In this embodiment of this application, the third operation corresponds to the first operation, and may also be an operation such as sliding or dragging on the first control. This is not limited in this application.

For example, referring to FIG. 9, when an initial magnification (that is, a magnification when adjustment of a sighting telescope is triggered) is 6 times, when a magnification rate in a selected state is 6 times, touching and holding on the first control is stopped (that is, the user releases the first control), and the 6 times may be determined as a magnification of the adjusted virtual sighting telescope, that is, the magnification does not change. When the magnification in the selected state is 8 times, the touching and holding on the first control is stopped, and the magnification changes to 8 times. Similarly, referring to FIG. 10, when an initial magnification is 6 times, when a magnification in a selected state is 6 times, touching and holding on the first control is stopped, and the 6 times may be determined as a magnification of the adjusted virtual sighting telescope, that is, the magnification remains unchanged. When the magnification in the selected state is 4 times, the touching and holding on the first control is stopped, and the magnification changes to 4 times. When the magnification in the selected state is 2 times, the touching and holding on the first control is stopped, and the magnification changes to 2 times.

In the foregoing method, a parameter adjustment process of the virtual sighting telescope may be ended when the user confirms that the parameter has been adjusted to an appropriate parameter.

In some embodiments, a cancel option is displayed. In some embodiments, the parameter adjustment interface includes the cancel option, and in response to the third operation for confirming a selection, when the cancel option is in a selected state, it is determined not to adjust the parameter of the virtual sighting telescope. In some embodiments, the cancel option is a UI control. In some embodiments, in response to an operation on the cancel control, it is determined not to adjust the parameter of the virtual sighting telescope.

For example, referring to FIG. 9, when an initial magnification is 6 times, when an option in a selected state is a cancel option 91, touching and holding on the first control is stopped, it is determined that the parameter of the virtual sighting telescope is not adjusted, and the magnification of the virtual sighting telescope is still 6 times. Similarly, referring to FIG. 10, when an initial magnification is 6 times, when an option in a selected state is a cancel option 91, touching and holding on the first control is stopped, it is determined that the parameter of the virtual sighting telescope is not adjusted, and the magnification of the virtual sighting telescope is still 6 times. The cancel option 91 is not fully marked in FIG. 9 and FIG. 10, and only partial marks are used as an exemplary description in FIG. 9 and FIG. 10.

In the foregoing method, when the user confirms that the parameter does not need to be adjusted, adjustment of the parameter of the virtual sighting telescope is canceled to avoid occurrence of a case such as a false touch, thereby improving an error tolerance rate and further improving human-computer interaction efficiency.

In some embodiments, the plurality of candidate parameters are displayed in a longitudinal arrangement on a screen of the terminal device, and the first axis is perpendicular to the plane in which the screen of the terminal device is located.

In some embodiments, as shown in FIG. 11, the plurality of candidate parameters are displayed in a longitudinal arrangement on the screen of the terminal device. Correspondingly, the first axis may be the z-axis shown in FIG. 8. For example, if the terminal device is rotated along the clockwise direction around the z-axis shown in FIG. 8, the parameter in the selected state in FIG. 11 may be switched from "6X" to "8X". When the terminal device is rotated along the anticlockwise direction around the z-axis shown in FIG. 8, the parameter in the selected state in FIG. 11 may be switched from "6X" to "4X".

In some embodiments, when the prompt information is displayed, the plurality of candidate parameters are displayed in a longitudinal arrangement, the first axis being perpendicular to the plane in which the screen of the terminal device is located.

For example, the prompt information is displayed in a parameter adjustment interface, and the plurality of candidate parameters are displayed in a longitudinal arrangement. For example, the prompt information is displayed directly on an upper layer of the environment picture, and the plurality of candidate parameters are displayed in a longitudinal arrangement.

In some embodiments, while the prompt information is displayed, the plurality of candidate parameters are displayed in a horizontal arrangement, the first axis being parallel to the plane in which the screen of the terminal device is located, and the first axis being perpendicular to a straight line corresponding to an arrangement direction of the plurality of candidate parameters.

For example, the prompt information is displayed in a parameter adjustment interface, and the plurality of candidate parameters are displayed in a horizontal arrangement. For example, the prompt information is displayed directly on an upper layer of the environment picture, and the plurality of candidate parameters are displayed in a longitudinal arrangement.

In some embodiments, the plurality of candidate parameters are displayed in a horizontal arrangement on the screen of the terminal device, the first axis being parallel to a plane in which the screen of the terminal device is located, and the first axis being perpendicular to a straight line corresponding to an arrangement direction of the plurality of candidate parameters.

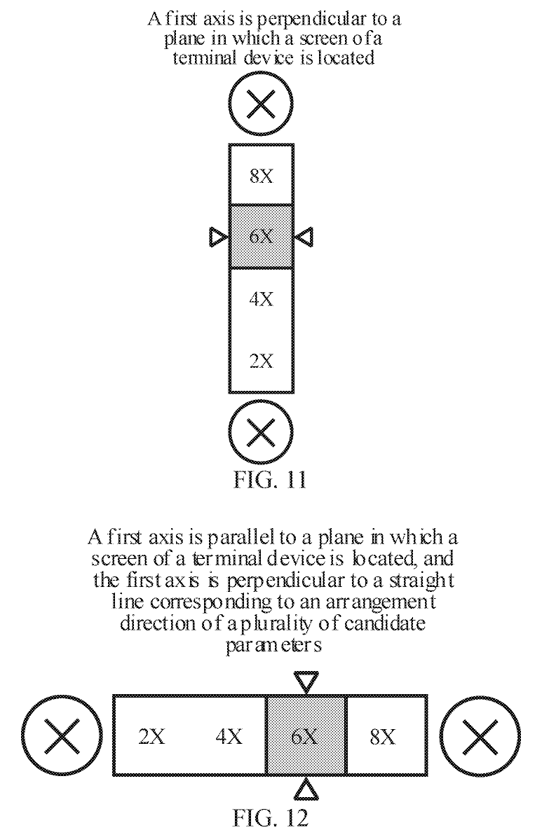

In some embodiments, as shown in FIG. 12, the plurality of candidate parameters are displayed in a horizontal arrangement on the screen of the terminal device. Correspondingly, the first axis may be the x-axis shown in FIG. 8. For example, if the terminal device is rotated along the clockwise direction around the x-axis shown in FIG. 8, the parameter in the selected state in FIG. 12 may be switched from "6X" to "8X". When the terminal device is rotated along the anticlockwise direction around the x-axis shown in FIG. 8, the parameter in the selected state in FIG. 12 may be switched from "6X" to "4X".

In the foregoing method, the arrangement manners of the plurality of candidate parameters and the first axis are set in an associated manner, so that the parameter adjustment interface corresponds to an axis to which a user refers during rotation, and better satisfies a habit of the user, thereby improving efficiency of adjusting the parameter of the virtual sighting telescope by the user.

In some embodiments, when the terminal device rotates around the first axis toward the first direction or around the second axis toward the second direction, and the parameter in the selected state is a boundary parameter of the virtual sighting telescope, in response to the end operation of the first operation or the end operation of the second operation, a third environment picture obtained by observing the virtual environment through a switched virtual sighting telescope is displayed. The switched virtual sighting telescope is another virtual sighting telescope obtained by switching the virtual sighting telescope, and the switched virtual sighting telescope and the virtual sighting telescope have different boundary parameters.

For example, in response to the end operation of the first operation or the end operation of the second operation, a parameter of the switched virtual sighting telescope is determined. A third environment picture obtained by observing the virtual environment through the switched virtual sighting telescope is displayed. For the end operation of the first operation or the end operation of the second operation herein, refer to the explanations and descriptions in the foregoing embodiments. Details are not described herein again.

In some embodiments, when the terminal device rotates around a first axis toward a first direction or around a second axis toward a second direction, if the parameter in the selected state is a boundary parameter of the virtual sighting telescope, the virtual sighting telescope is switched to another virtual sighting telescope. The another virtual sighting telescope and the virtual sighting telescope have different boundary parameters.

The boundary parameter of the virtual sighting telescope refers to a parameter at a boundary of a parameter range corresponding to any parameter type (such as a magnification) of the virtual sighting telescope. In some embodiments, the boundary parameter of the virtual sighting telescope refers to an extremum (a relative maximum and a relative minimum) of the parameter supported by the virtual sighting telescope. For example, referring to FIG. 7, the magnification "8X" and the magnification "2X" are boundary parameters corresponding to the virtual sighting telescope.

In some embodiments, when the terminal device rotates around a first axis toward a first direction, if the parameter in the selected state is a relative maximum of a parameter of a particular type of the virtual sighting telescope, the virtual sighting telescope is switched to another virtual sighting telescope, and the another virtual sighting telescope supports a larger relative maximum for the parameter type. In some embodiments, when the terminal device rotates around a first axis toward a first direction, if the parameter in the selected state is an absolute maximum of a parameter of a particular type of the virtual sighting telescope, the virtual sighting telescope is switched to another virtual sighting telescope, and the another virtual sighting telescope supports a larger absolute maximum for the parameter type.

In some embodiments, when the terminal device rotates around a first axis toward a second direction, if the parameter in the selected state is a relative minimum of a parameter of a particular type of the virtual sighting telescope, the virtual sighting telescope is switched to another virtual sighting telescope, and the another virtual sighting telescope supports a smaller relative minimum for the parameter type.

For example, it is assumed that a first-type virtual sighting telescope supports a magnification of 4 times to 8 times, and a second-type virtual sighting telescope supports a magnification of 3 times to 6 times. In this case, during adjustment of the second-type virtual sighting telescope, when the terminal device rotates clockwise round the first axis, if the parameter in the selected state is the magnification of "6X", the virtual sighting telescope may be switched to the first-type virtual sighting telescope. Correspondingly, during adjustment of the first-type virtual sighting telescope, when the terminal device rotates anticlockwise around the first axis, if the parameter in the selected state is the magnification of "4X", the virtual sighting telescope may be switched to the second-type virtual sighting telescope.

In some embodiments, when the terminal device rotates around the first axis toward the first direction or the second direction, if the parameter in the selected state is the boundary parameter of the virtual sighting telescope, prompt information is displayed, the prompt information being configured for indicating whether the user has another virtual sighting telescope that can meet a parameter requirement.

In the foregoing method, when a user needs to use a virtual sighting telescope having a different parameter range (a relative maximum of a magnification being higher or a relative minimum of a magnification being lower), the virtual sighting telescope may be automatically switched, thereby saving an operation of replacing the virtual sighting telescope by the user.

In some embodiments, an acceleration sensor is further provided in the terminal device, and the foregoing adjustment method for a virtual sighting telescope further includes the following operations:

1: Obtain second motion data collected by the acceleration sensor, the second motion data being used for representing an acceleration of the terminal device.

The acceleration sensor is configured to measure an acceleration of the terminal device. For example, the acceleration sensor may separately measure accelerations in an x-axis direction, a y-axis direction, and a z-axis direction shown in FIG. 8.

The second motion data may be acceleration data of the terminal device in any direction.

2: Perform, when the acceleration of the terminal device is greater than or equal to a third threshold, the operation of displaying, in response to a second operation for adjusting a posture of the terminal device, a second environment picture obtained by observing the virtual environment through an adjusted virtual sighting telescope.

For example, as shown in FIG. 8, if the acceleration of the terminal device in any one of the x-axis direction, the y-axis direction, and the z-axis direction is greater than the third threshold, the operation of displaying, in response to a second operation for adjusting a posture of the terminal device, a second environment picture obtained by observing the virtual environment through an adjusted virtual sighting telescope is performed.

The third threshold may be set by a technical person according to requirements. For example, the third threshold may be 20 cm/s2, 30 cm/s2, 50 cm/s2, and the like. This is not limited in this application.

In the foregoing method, the virtual sighting telescope can be prevented from being adjusted without being perceived by the user (when the user slowly changes the posture of the terminal device without being perceived), so as to improve efficiency of adjusting the virtual sighting telescope.

The foregoing adjustment method for a virtual sighting telescope may be applied to a game application, for example, a client of a shooter game. The following describes, by using an embodiment, a complete solution of adjusting a magnification of a virtual sighting telescope in a shooter game. The solution includes at least one of the following operations:

1: Display a game interface, controls related to the shooter game (for example, a shooting control for controlling a virtual character to shoot, a movement control for controlling a virtual character to move, and a settings control and an open control mentioned in the foregoing embodiments) and a virtual environment being displayed in the game interface.

2: Display a settings interface in the game interface in response to a click/tap operation performed by a user on the settings control, the settings interface displaying a "gyroscope switching sighting telescope" option shown in FIG. 6. The user may turn on or off the option through a click/tap or slide operation. When the option is turned on, adjustment of the virtual sighting telescope is allowed to be controlled according to the first motion data collected by the gyroscope. In the following embodiment, the option may be considered as being turned on.

3: Display, in response to an open operation of the user (for example, a click/tap operation on the open control), the first environment picture obtained by observing the virtual environment through the virtual sighting telescope, and display a first control.

4: Display a parameter adjustment interface in response to a touch and hold operation of the user on the first control. The parameter adjustment interface displays a plurality of candidate magnifications supported by the virtual sighting telescope and prompt information. The prompt information herein is configured for marking a magnification in a selected state from the plurality of candidate magnifications. The magnification in the selected state may indicate a magnification currently used by the virtual sighting telescope. For example, in this case, if the magnification of "6X" is marked, it indicates that the magnification currently used by the virtual sighting telescope is 6 times, and the first environment picture is zoomed in by 6 times compared with the virtual environment.

5: When the user continuously presses the first control, the magnification in the selected state increases (for example, increases from "6X" to "8X") in response to that the terminal device rotates clockwise around the first axis (for example, the z-axis in FIG. 8) and a rotation angle is greater than or equal to the first threshold (for example, 15 degrees). In addition, a second environment picture obtained by observing the virtual environment through the adjusted virtual sighting telescope is displayed, and the second environment picture is zoomed in for display compared with the first environment picture. Alternatively, in response to that the terminal device rotates anticlockwise around the first axis, and the rotation angle is greater than or equal to the first threshold (for example, 15 degrees), the magnification in the selected state decreases (for example, decreases from "6X" to "4X"). In addition, the second environment picture obtained by observing the virtual environment through the adjusted virtual sighting telescope is displayed, and the second environment picture is zoomed out compared with the first environment picture.

6: Determine, in response to that the user stops pressing the first control, the magnification in the selected state (for example, "8X") as a magnification finally used by the adjusted virtual sighting telescope. In this case, the second environment picture is zoomed in by 8 times compared with the virtual environment. In addition, display of the parameter adjustment interface is canceled. When the user does not press the first control, rotation of the terminal device does not change the magnification of the virtual sighting telescope, and does not change the environment picture obtained by observing the virtual environment through the virtual sighting telescope. In this case, it may be considered that adjustment of the magnification of the virtual sighting telescope is completed.

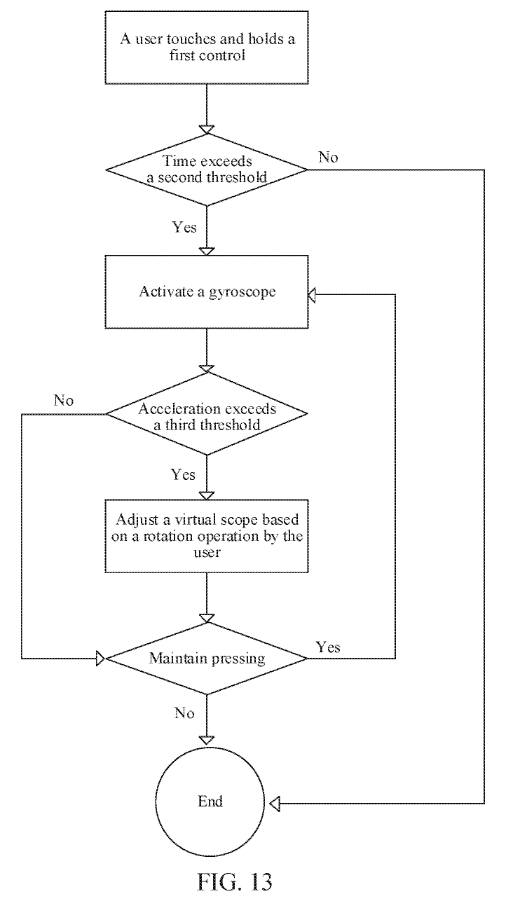

FIG. 13 is a flowchart of triggering and ending adjustment of a virtual sighting telescope according to an embodiment of this application. The solution includes at least one of the following operations:

1: Detect whether a duration for which a user touches and holds a first control exceeds a second threshold, and if yes, activate a gyroscope, and obtain first motion data collected by the gyroscope.

2: Detect whether an acceleration of a terminal device in any direction is greater than or equal to a third threshold, and if yes, display, in response to a second operation for adjusting a posture of the terminal device, a second environment picture obtained by observing a virtual environment through an adjusted virtual sighting telescope (adjust a virtual sighting telescope based on a rotation operation by the user).

3: Detect whether the user maintains a pressing state on the first control, and if no, end adjustment of the virtual sighting telescope.

FIG. 14 is a flowchart of an adjustment solution of a virtual sighting telescope according to an embodiment of this application. The solution includes at least one of the following operations:

1: Obtain, in response to a touch and hold operation on a first control, first motion data collected by a gyroscope.

2. Adjust, in response to a rotation operation on a terminal device, a display status of a picture obtained by observing a virtual environment through a virtual sighting telescope (the picture being zoomed in corresponds to a magnification being increased, and the picture being zoomed out corresponds to the magnification being decreased).

3. Determine, in response to a user stopping touching and holding of the first control, when a cancel option is in a selected state, not to adjust a parameter of the virtual sighting telescope, or determine a magnification in a selected state as a magnification of an adjusted virtual sighting telescope.

Certainly, the virtual sighting telescope mentioned in this embodiment of this application is not limited to a prop of a type of a sighting telescope. Another virtual object with an adjustable parameter is also considered as a virtual sighting telescope in this application, and the adjustment method in this application is applicable thereto. For example, the virtual object with an adjustable parameter includes, but is not limited to, a virtual attack prop, a virtual character, and a virtual plant.

In a first case, a virtual object with an adjustable parameter is a virtual attack prop.

In some embodiments, an environment picture including the virtual attack prop before parameter adjustment is displayed.

In some embodiments, in response to an operation for triggering adjustment of the virtual attack prop, first motion data collected by the gyroscope is obtained, and the first motion data is used for determining a posture change status of the terminal device.

In some embodiments, an environment picture including the virtual attack prop after parameter adjustment is displayed in response to a second operation for adjusting the posture of the terminal device. A parameter of an adjusted virtual attack prop is obtained by adjusting the parameter of the virtual attack prop based on the first motion data.

For example, a parameter type (that is, an adjustable parameter) of the parameter of the virtual attack prop includes, but is not limited to: a quantity of virtual attack props, an appearance of a virtual attack prop, and an attribute of a virtual attack prop.

In a second case, a virtual object with an adjustable parameter is a virtual character.

In some embodiments, an environment picture including the virtual character before parameter adjustment is displayed.

In some embodiments, in response to an operation for triggering adjustment of the virtual character, first motion data collected by the gyroscope is obtained, and the first motion data is used for determining a posture change status of the terminal device.

In some embodiments, the environment picture including the virtual character after parameter adjustment is displayed in response to the second operation for adjusting the posture of the terminal device. A parameter of an adjusted virtual character is obtained by adjusting the parameter of the virtual character based on the first motion data.

For example, a parameter type (that is, an adjustable parameter) of the parameter of the virtual character includes, but is not limited to: a quantity of virtual characters, an appearance of a virtual character, and an attribute of the virtual character.

In a third case, a virtual object with an adjustable parameter is a virtual plant.

In some embodiments, an environment picture including a virtual plant before parameter adjustment is displayed.

In some embodiments, in response to an operation for triggering adjustment of the virtual plant, first motion data collected by the gyroscope is obtained, and the first motion data is used for determining a posture change status of the terminal device.

In some embodiments, an environment picture including the virtual plant after parameter adjustment is displayed in response to a second operation for adjusting the posture of the terminal device. A parameter of an adjusted virtual plant is obtained by adjusting the parameter of the virtual plant based on the first motion data.

For example, parameter types (that is, adjustable parameters) of the parameters of the virtual plants include, but are not limited to: the number of the virtual plants, the appearance of the virtual plants, a planting area of the virtual plants, varieties of the virtual plants, and attributes of the virtual plants.

The following describes apparatus embodiments of this application, which may be used for executing the method embodiments of this application. For details not disclosed in the apparatus embodiments of this application, refer to the method embodiments of this application.

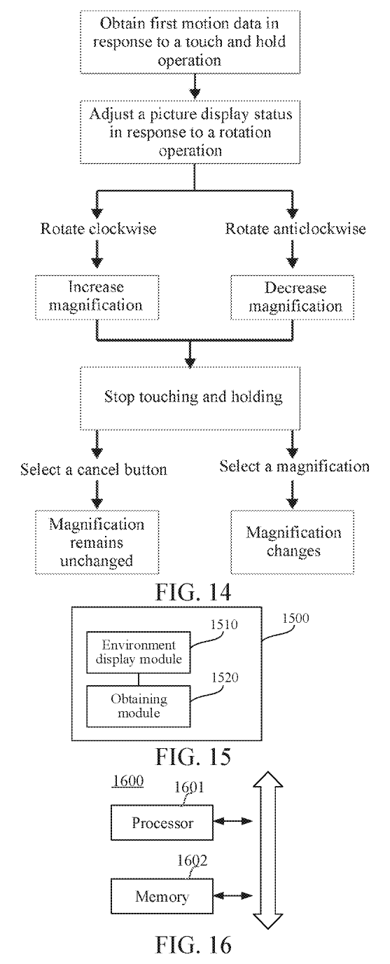

FIG. 15 is a block diagram of an adjustment apparatus for a virtual sighting telescope according to an embodiment of this application. The apparatus has a function of implementing the foregoing adjustment method for a virtual sighting telescope. The function may be implemented by hardware or by executing corresponding software by hardware. The apparatus may be a terminal device, or may be provided in a terminal device. A gyroscope is provided in the terminal device. The apparatus 1500 may include an environment display module 1510 and an obtaining module 1520.

The environment display module 1510 is configured to display a first environment picture obtained by observing a virtual environment through the virtual sighting telescope.

The obtaining module 1520 is configured to obtain, in response to a first operation for triggering adjustment of the virtual sighting telescope, first motion data collected by the gyroscope, the first motion data being used for determining a posture change status of the terminal device.

The environment display module 1510 is further configured to display, in response to a second operation for adjusting a posture of the terminal device, a second environment picture obtained by observing the virtual environment through an adjusted virtual sighting telescope; a parameter of the adjusted virtual sighting telescope being obtained by adjusting a parameter of the virtual sighting telescope based on the first motion data.

In some embodiments, the apparatus 1500 further includes a parameter display module (not shown in FIG. 15).

The parameter display module is configured to display prompt information in response to the second operation, the prompt information being configured for indicating a parameter in a selected state among a plurality of candidate parameters, the plurality of candidate parameters being parameters supported by the virtual sighting telescope, and the parameter in the selected state being determined by the posture of the terminal device adjusted by the second operation.

The environment display module 1510 is further configured to display the second environment picture in response to an end operation of the second operation or an end operation of the first operation, the parameter of the adjusted virtual sighting telescope being the parameter in the selected state.

In some embodiments, the second operation is an operation of controlling the terminal device to rotate around an axis.

In some embodiments, the parameter display module is configured to display, when the terminal device rotates around a first axis toward a first direction and a rotation angle is greater than or equal to a first threshold, that the parameter in the selected state changes from a first parameter to a second parameter; and display, when the terminal device rotates around a second axis toward a second direction and a rotation angle is greater than or equal to a first threshold, that the parameter in the selected state changes from a first parameter to a third parameter, the second parameter being different from the third parameter; the first axis and the second axis being a same axis, and the first direction and the second direction being different directions; or the first axis and the second axis being different axes, and the first direction and the second direction being a same direction or different directions.

In some embodiments, the parameter display module is configured to display the plurality of candidate parameters in a longitudinal arrangement when the prompt information is displayed, the first axis being perpendicular to a plane in which a screen of the terminal device is located; or display the plurality of candidate parameters in a horizontal arrangement while displaying the prompt information, the first axis being parallel to a plane in which a screen of the terminal device is located, and the first axis being perpendicular to a straight line corresponding to an arrangement direction of the plurality of candidate parameters.

In some embodiments, the environment display module 1510 is further configured to display, in response to the end operation of the first operation or the end operation of the second operation when the terminal device rotates around the first axis toward the first direction or around the second axis toward the second direction and the parameter in the selected state is a boundary parameter of the virtual sighting telescope, a third environment picture obtained by observing the virtual environment through a switched virtual sighting telescope; the switched virtual sighting telescope being another virtual sighting telescope obtained by switching the virtual sighting telescope, and the switched virtual sighting telescope and the virtual sighting telescope having different boundary parameters.

In some embodiments, the parameter display module is configured to determine the parameter in the selected state as the parameter of the adjusted virtual sighting telescope in response to a third operation for confirming a selection, the third operation being the end operation of the second operation or the end operation of the first operation.

In some embodiments, the parameter display module is configured to display a cancel option; and determine, in response to the third operation when the cancel option is in the selected state, not to adjust the parameter of the virtual sighting telescope.

In some embodiments, the parameter display module is configured to determine, according to the first operation or the second operation, a first parameter type to be adjusted from a plurality of parameter types of the virtual sighting telescope; and display a parameter adjustment interface of the first parameter type, the parameter adjustment interface displaying the prompt information and the plurality of candidate parameters that belong to the first parameter type.

In some embodiments, the parameter display module is configured to control, when the parameter in the selected state changes, the terminal device to generate a vibration feedback.

In some embodiments, the first operation includes an operation on a first control, the first control being a control configured for triggering adjustment of the virtual sighting telescope.

In some embodiments, the obtaining module 1520 is configured to obtain, in response to the operation on the first control when duration of the operation on the first control is greater than or equal to a second threshold, the first motion data collected by the gyroscope.

In some embodiments, an acceleration sensor is further provided in the terminal device.

In some embodiments, the obtaining module 1520 is configured to obtain second motion data collected by the acceleration sensor, the second motion data being used for representing an acceleration of the terminal device; and when the acceleration of the terminal device is greater than or equal to a third threshold, the environment display module 1510 is configured to perform the operation of displaying, in response to a second operation for adjusting a posture of the terminal device, a second environment picture obtained by observing the virtual environment through an adjusted virtual sighting telescope.

In the technical solution provided in this embodiment of this application, a first environment picture obtained by observing a virtual environment through a virtual sighting telescope is displayed. Then, first motion data used for determining a posture change status of a terminal device is obtained in response to a first operation for triggering adjustment of the virtual sighting telescope. In addition, a second environment picture obtained by observing the virtual environment through an adjusted virtual sighting telescope is displayed in response to a second operation for adjusting a posture of the terminal device. In this way, when adjustment of the virtual sighting telescope is triggered, picture display of the virtual sighting telescope can be adjusted only by adjusting the posture of the terminal device, so that an operation of adjusting the virtual sighting telescope is simplified, and efficiency of adjusting the virtual sighting telescope is improved.

When the apparatus provided in the foregoing embodiments implements functions of the apparatus, the division of the foregoing functional modules is merely an example for description. In practice, the functions may be assigned to and completed by different functional modules according to requirements, that is, the internal structure of the device is divided into different functional modules, to complete all or some of the functions described above. In addition, the apparatus and method embodiments provided in the foregoing embodiments are based on the same concept. For details of a specific implementation process of the apparatus, refer to the method embodiments. Details are not described herein again.

FIG. 16 is an example of a structural block diagram of a terminal device according to an embodiment of this application.

Generally, the terminal device 1600 includes a processor 1601 and a memory 1602.

The processor 1601 may include one or more processing cores, for example, a 4-core processor or an 8-core processor. The processor 1601 may be implemented in at least one hardware form of a digital signal processor (DSP), a field-programmable gate array (FPGA), and a programmable logic array (PLA). The processor 1601 may also include a main processor and a coprocessor. The main processor is a processor configured to process data in an awake state, and is also referred to as a central processing unit (CPU). The coprocessor is a low power consumption processor configured to process data in a standby state. In some embodiments, the processor 1601 may be integrated with a graphics processing unit (GPU). The GPU is configured to render and draw content that needs to be displayed on a display screen. In some embodiments, the processor 1601 may further include an artificial intelligence (AI) processor. The AI processor is configured to process computing operations related to machine learning.

The memory 1602 may include one or more computer-readable storage media. The computer-readable storage medium may be tangible and non-transitory. The memory 1602 may further include a high-speed random access memory and a nonvolatile memory, for example, one or more magnetic disk storage devices or flash storage devices. In some embodiments, the non-transitory computer-readable storage medium in the memory 1602 has a computer program stored therein, and the computer program is loaded and executed by the processor 1601 to implement the foregoing adjustment method for a virtual sighting telescope.

A person skilled in the art may understand that the structure shown in FIG. 16 constitutes no limitation on the terminal device 1600, and the terminal device may include more or fewer components than those shown in the figure, or some components may be combined, or a different component deployment may be used.

In some embodiments, a computer-readable storage medium is further provided, having a computer program stored therein, the computer program being loaded and executed by a processor to implement the foregoing adjustment method for a virtual sighting telescope.

In some embodiments, the computer-readable storage medium may include: a read-only memory (ROM), a random-access memory (RAM), a solid state drive (SSD), an optical disc, or the like. The RAM may include a resistance RAM (ReRAM) and a dynamic RAM (DRAM).

In some embodiments, a computer program product is further provided, including a computer program, the computer program being stored in a computer-readable storage medium, and a processor reading the computer program from the computer-readable storage medium and executing the computer program, to implement the foregoing adjustment method for a virtual sighting telescope.

"A plurality of" mentioned in this specification means two or more. The term "and/or" describes an association relationship between associated objects and indicates that three relationships may exist. For example, A and/or B may represent the following three cases: Only A exists, both A and B exist, and only B exists. The character "/" generally indicates an "or" relationship between the associated objects. In addition, the operation numbers described in this specification merely exemplarily show a possible execution sequence of the operations. In some other embodiments, the operations may not be performed according to the number sequence. For example, two operations with different numbers may be performed simultaneously, or two operations with different numbers may be performed according to a sequence contrary to the sequence shown in the figure. This is not limited in the embodiments of this application.

The foregoing descriptions are merely exemplary embodiments of this application, and are not intended to limit this application. Any modification, equivalent replacement, improvement, and the like made within the spirit and principle of this application are included within the protection scope of this application.

What is claimed is:

1. A method for adjusting a virtual sighting telescope performed by a computer device, the method comprising:
displaying a first environment picture obtained by observing a virtual environment through the virtual sighting telescope;
in response to a first operation for triggering adjustment of the virtual sighting telescope, obtaining first motion data collected by a gyroscope of the computer device for determining a posture change status of the computer device; and
in response to a second operation for adjusting a posture of the computer device, displaying a second environment picture obtained by observing the virtual environment through an adjusted virtual sighting telescope.

2. The method according to claim 1, wherein a parameter of the adjusted virtual sighting telescope is obtained by adjusting a parameter of the virtual sighting telescope based on the first motion data.

3. The method according to claim 1, wherein the displaying a second environment picture obtained by observing the virtual environment through an adjusted virtual sighting telescope comprises:
displaying prompt information in response to the second operation, the prompt information being configured for indicating a parameter in a selected state among a plurality of candidate parameters, the plurality of candidate parameters being parameters supported by the virtual sighting telescope, and the parameter in the selected state being determined by the posture of the computer device adjusted by the second operation; and
displaying the second environment picture in response to an end operation of the second operation or an end operation of the first operation, the parameter of the adjusted virtual sighting telescope being the parameter in the selected state.

4. The method according to claim 2, wherein the second operation is an operation of controlling the computer device to rotate around an axis; and
the displaying prompt information in response to the second operation comprises:
displaying, when the computer device rotates around a first axis toward a first direction and a rotation angle is greater than or equal to a first threshold, that the parameter in the selected state changes from a first parameter to a second parameter; or
displaying, when the computer device rotates around a second axis toward a second direction and a rotation angle is greater than or equal to a first threshold, that the parameter in the selected state changes from a first parameter to a third parameter, the second parameter being different from the third parameter;
the first axis and the second axis being a same axis, and the first direction and the second direction being different directions; or the first axis and the second axis being different axes, and the first direction and the second direction being a same direction or different directions.

5. The method according to claim 2, further comprising:
determining the parameter in the selected state as the parameter of the adjusted virtual sighting telescope in response to a third operation for confirming a selection, the third operation being the end operation of the second operation or the end operation of the first operation.

6. The method according to claim 2, further comprising:
displaying a cancel option; and
determining, in response to the third operation when the cancel option is in the selected state, not to adjust the parameter of the virtual sighting telescope.

7. The method according to claim 2, further comprising:
determining, according to the first operation or the second operation, a first parameter type to be adjusted from a plurality of parameter types of the virtual sighting telescope; and
displaying a parameter adjustment interface of the first parameter type, the parameter adjustment interface displaying the prompt information and the plurality of candidate parameters that belong to the first parameter type.

8. The method according to claim 2, further comprising:
controlling, when the parameter in the selected state changes, the computer device to generate a vibration feedback.

9. The method according to claim 1, wherein the first operation comprises an operation on a first control, the first control being a control configured for triggering adjustment of the virtual sighting telescope.

10. The method according to claim 1, wherein an acceleration sensor is further provided in the computer device, and the method further comprises:
obtaining second motion data collected by the acceleration sensor, the second motion data being used for representing an acceleration of the computer device; and
performing, when the acceleration of the computer device is greater than or equal to a third threshold, the operation of displaying, in response to a second operation for adjusting a posture of the computer device, a second environment picture obtained by observing the virtual environment through an adjusted virtual sighting telescope.

11. A computer device, comprising a processor and a memory, the memory having a computer program stored therein, the computer program, when being loaded and executed by the processor , causing the computer device to implement a method for adjusting a virtual sighting telescope including:
displaying a first environment picture obtained by observing a virtual environment through the virtual sighting telescope;
in response to a first operation for triggering adjustment of the virtual sighting telescope, obtaining first motion data collected by a gyroscope of the computer device for determining a posture change status of the computer device; and
in response to a second operation for adjusting a posture of the computer device, displaying a second environment picture obtained by observing the virtual environment through an adjusted virtual sighting telescope.

12. The computer device according to claim 11, wherein a parameter of the adjusted virtual sighting telescope is obtained by adjusting a parameter of the virtual sighting telescope based on the first motion data.

13. The computer device according to claim 11, wherein the displaying a second environment picture obtained by observing the virtual environment through an adjusted virtual sighting telescope comprises:
displaying prompt information in response to the second operation, the prompt information being configured for indicating a parameter in a selected state among a plurality of candidate parameters, the plurality of candidate parameters being parameters supported by the virtual sighting telescope, and the parameter in the selected state being determined by the posture of the computer device adjusted by the second operation; and
displaying the second environment picture in response to an end operation of the second operation or an end operation of the first operation, the parameter of the adjusted virtual sighting telescope being the parameter in the selected state.

14. The computer device according to claim 12, wherein the second operation is an operation of controlling the computer device to rotate around an axis; and
the displaying prompt information in response to the second operation comprises:
displaying, when the computer device rotates around a first axis toward a first direction and a rotation angle is greater than or equal to a first threshold, that the parameter in the selected state changes from a first parameter to a second parameter; or
displaying, when the computer device rotates around a second axis toward a second direction and a rotation angle is greater than or equal to a first threshold, that the parameter in the selected state changes from a first parameter to a third parameter, the second parameter being different from the third parameter;
the first axis and the second axis being a same axis, and the first direction and the second direction being different directions; or the first axis and the second axis being different axes, and the first direction and the second direction being a same direction or different directions.

15. The computer device according to claim 12, wherein the method further comprises:
determining the parameter in the selected state as the parameter of the adjusted virtual sighting telescope in response to a third operation for confirming a selection, the third operation being the end operation of the second operation or the end operation of the first operation.

16. The computer device according to claim 12, wherein the method further comprises:
displaying a cancel option; and
determining, in response to the third operation when the cancel option is in the selected state, not to adjust the parameter of the virtual sighting telescope.

17. The computer device according to claim 12, wherein the method further comprises:
determining, according to the first operation or the second operation, a first parameter type to be adjusted from a plurality of parameter types of the virtual sighting telescope; and
displaying a parameter adjustment interface of the first parameter type, the parameter adjustment interface displaying the prompt information and the plurality of candidate parameters that belong to the first parameter type.

18. The computer device according to claim 12, wherein the method further comprises:
controlling, when the parameter in the selected state changes, the computer device to generate a vibration feedback.

19. The computer device according to claim 11, wherein the first operation comprises an operation on a first control, the first control being a control configured for triggering adjustment of the virtual sighting telescope.

20. A non-transitory computer-readable storage medium, having a computer program stored therein, the computer program, when being loaded and executed by a processor of a computer device, causing the computer device to implement a method for adjusting a virtual sighting telescope including:
displaying a first environment picture obtained by observing a virtual environment through the virtual sighting telescope;
in response to a first operation for triggering adjustment of the virtual sighting telescope, obtaining first motion data collected by a gyroscope of the computer device for determining a posture change status of the computer device; and
in response to a second operation for adjusting a posture of the computer device, displaying a second environment picture obtained by observing the virtual environment through an adjusted virtual sighting telescope.
